(19) United States
(12) Patent Application Publication
(10) Pub. No.: US 2003/0214075 A1
(43) Pub. Date: Nov. 20, 2003

(54) Open mold manufacturing process with centralized application station

(76) Inventor: Charles M. Brown, Jackson, TN (US)

Correspondence Address: CARLSON, GASKEY & OLDS, P.C., 400 WEST MAPLE ROAD, SUITE 350, BIRMINGHAM, MI, 48009, US

(21) Appl. No.: 10/146,275

(22) Filed: May 15, 2002

(51) Int. Cl. B29C 31/00; B29C 35/00

(52) U.S. Cl. 264/297.6; 264/297.8; 264/309; 264/319; 249/118

(57) ABSTRACT

A mold manufacturing system includes a conveyer circuit upon which a multiple of molds transit a closed loop and repetitively pass through a central booth. The system is separated into Zones in which a particular mold operation is performed. Each of a multiple of applying operations are performed within the central booth which contains a common exhaust plenum. Application of exceedingly expensive environmental emission control devices is at least partially mitigated. Consolidation of multiple spray operations into a few spray Zones also advantageously simplifies the control of chemical and ambient variables which improves production efficiencies and reduces operator dependency.

### BACKGROUND OF THE INVENTION

The present invention relates to an open mold manufacturing process, and more particularly to a manufacturing system in which molds make a single lap while passing through a centralized application station a multiple of times.

Open mold fiberglass reinforced plastic molding systems are well known. Molds typically travel along a linear assembly line. A plurality of operations are performed at stations along the assembly line until a finished part is removed from the mold at the end of the assembly line.

Multiple stations along the assembly line are spray stations. As the molds transit the spray station a particular spraying operation is performed. Such spray operations include gelcoat and resin/catalyst/chopped fiberglass fixture application. Multiple coats are often required for one or more spraying operations necessitating additional spray stations. Stringent environmental regulations apply to these spraying operations as the sprayed material involves several chemical reactions. Conventional spray stations provide an open environment in which an airflow is directed from behind a spray operator to direct mold overspray into an exhaust port.

Environmental regulations are becoming more and more inflexible. The expense of providing environmental emission control devices which meet environmental regulations often results in cost prohibitive manufacturing facilities. Often older facilities become non-compliant and must be idled. The expense of the regulation may be particularly high for an assembly line type molding system as spraying occurs at multiple locations along the assembly line. The entire facility is therefore typically subjected to particularly harsh environmental regulations.

Assembly line type molding systems require a rather large manufacturing facility footprint as a curing station follows each spraying station. The linear nature of the assembly line environment provides for constant movement of the molds. The curing stations must be of a length to assure proper curing of the prior spray operation. Multiple lengthy curing stations greatly lengthens the assembly line. A larger manufacturing facility is subject to harsher environmental regulations than a smaller facility.

The sequential nature of the assembly line environment provides multiple spray stations spaced along its length. Each spray station is vulnerable to many exogenous variables that are difficult to control in a cost effective manner. Control of these variables is only magnified in larger manufacturing facilities.

Typically, human operators at each spray station are highly trained to minimize volatility in the manufacturing process. Many individual operators, even though highly trained, still may create manufacturing process volatilities due to variance in human technique and process manipulation. Robotic sprayers are often provided in place of operators to increase spraying consistency. However, this may simply result in many robotic spray stations replacing many human spray stations without a substantial reduction in expense.

Accordingly, it is desirable to provide an open mold manufacturing process which meets stringent environmental regulations within a small footprint facility. It is further desirable to minimize manufacturing process volatilities due to exogenous and human variables in a cost effective manner.

### SUMMARY OF THE INVENTION

The manufacturing system according to the present invention is utilized for open molding of large parts, and in particular bath tubs and shower surrounds. The system includes a conveyor circuit upon which a multiple of molds transit a closed loop. The molds transit the closed loop such that access is readily provided to the entire mold outer surface. The system is separated into Zones in which a particular mold operation is performed.

All spray operations occur within a central spray booth. The booth surrounds a common exhaust plenum. The high concentration of spraying and the associated low airflow requirements provides for more effective utilization of expensive environmental emission control devices. Moreover, as the spray Zones utilize the common exhaust plenum, a large number of spray operations (higher airflow lower spraying concentration) along a conventional assembly line type molding system are replaced by the centralized booth having low airflow and high spraying concentrations. Application of exceedingly expensive environmental emission control devices is therefore at least partially mitigated by the centralized spray booth in which low airflow requirements effectively remove the emissions and provide a much smaller factory footprint.

Each booth area includes a separate entry door and exit door through which the rail circuit passes. From the exit door of one spray Zone to the entry door of the next spray Zone, the molds traverse a trail circuit leg where one or more other mold operations are performed. The radial length of each rail circuit leg away from the central booth is related to the time required to perform the required operations before the next spray operation. Typically, a cure operation is provided along each leg.

The present invention therefore provides an open mold manufacturing process which meets stringent environmental regulations within a small footprint facility. The present invention also minimizes manufacturing process volatilities due to exogenous and human variables in a cost effective manner.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general floor plan view of a mold manufacturing system designed according to the present invention;

FIG. 2 is a chart diagramming operation of the mold manufacturing system;

FIG. 3 is a general floor plan view of a mold manufacturing system designed according to the present invention

### DETAILED DESCRIPTION OF THE PREFERRED EMBODIMENT

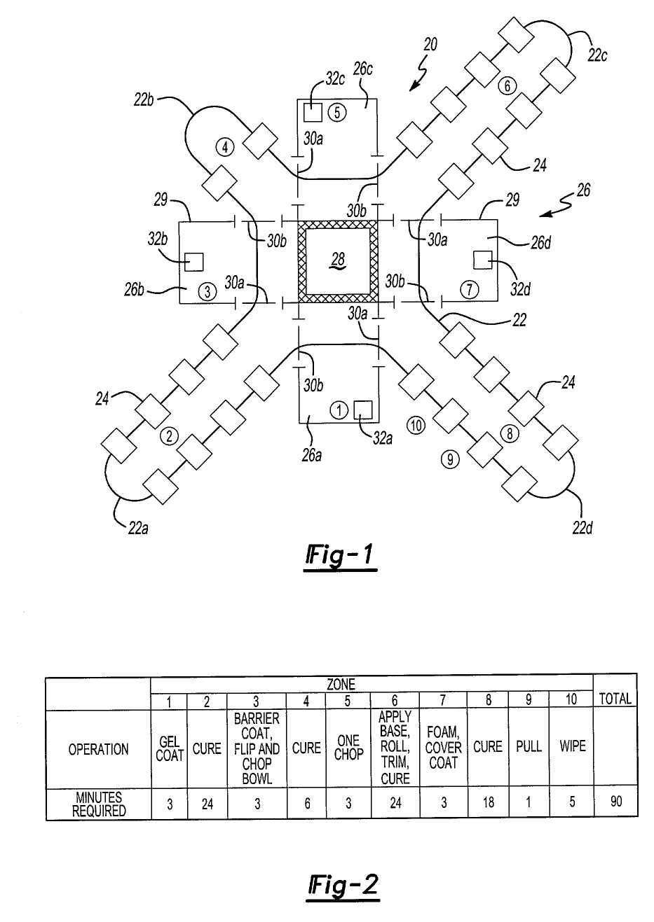

FIG. 1 illustrates a factory layout for a mold manufacturing system 20. System 20 is preferably utilized for open molding of large parts, and in particular bath tubs and shower surrounds. The system 20 includes a circuit 22 upon which a multiple of molds 24 transit a closed loop. The molds 24 preferably hang from an overhead rail system such that access is readily provided to the entire mold outer surface. Other transit systems such as conveyors, tracks, guided vehicles and the like will also benefit from the present invention.

The circuit 22 preferably defines an elongated cross like circuit in which the molds 24 move toward a spray booth 26, through the spray booth 26 and away from the spray booth 26 a multiple of times. In other words, the spray booth is a hub and the rail circuit is a closed circuit of radially extending spokes. Spraying occurs within the booth 26 a multiple of times during a single lap. It should be understood that although described as a “spray” other methods of application, such as dipping, swabbing, e-coating, or the like will also benefit form the present invention. The application processes for these materials are defined herein as environmentally controlled applying operations which are subject to certain government regulations.

The system 20 is separated into Zones in which a particular mold operation is performed (also disclosed in FIG. 2). The Zones may also be considered replaceable modules such that the present invention is not limited to just the defined number and operations, but may be tailored by the addition, subtraction and/or replacement of modules in which other operations are performed.

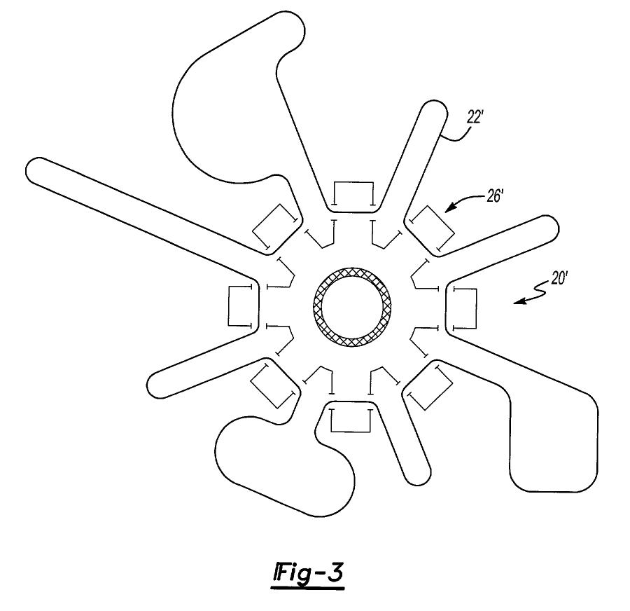

All spray operations occur within the central spray booth 26. The booth 26 surrounds a common exhaust plenum 28. Walls 29 or the like define and separate the spray booth 26 into spray zones defined as Zones 1, 3, 5 and 7 in which environmentally controlled applying operations are performed. As four spray Zones are provided in the illustrated embodiment, the booth 26 defines a substantially cross-shaped booth, however, other shapes (FIG. 3) will also benefit from the present invention. Each spray operation is performed in separate booth areas 26a, 26b, 26c and 26d yet all utilize the common exhaust plenum 28.

Concentrated spraying occurs in Zones 1, 3, 5, and 7. The high concentration of spraying and the associated low airflow requirements provides for more effective utilization of expensive environmental emission control devices. Moreover, as the spray Zones utilize the common exhaust plenum 28, a large number of spray operations (higher airflow lower spraying concentration) along a conventional assembly line type molding system are replaced by centralized booth 26 having low airflow and high spraying concentrations. Application of exceedingly expensive environmental emission control devices is therefore at least partially mitigated by the centralized spray booth 26 in which the low airflow requirements effectively remove the emissions and provide a much smaller factory footprint.

Preferably, each booth area 26a, 26b, 26c and 26d includes a separate entry door 30a and exit door 30b through which the circuit 22 passes. It should be understood that various well-known closures will benefit from the present invention. From the exit door 30b of one spray Zone to the entry door 30a of the next spray Zone, the molds 24 traverse one or more mold operations. A cure operation (Zone 2, 4, 6 and 8) occurs between each spray Zone 1, 3, 5 and 7. Most preferably, the radial length of each rail circuit leg 22a, 22b, 22c, and 22d away from the central exhaust plenum 28 is related to the time required to perform the required operations before the next spray operation (FIG. 2).

Zone 1 is an environmentally controlled applying operation in which the mold 22 is sprayed with a layer of resin referred herein as “gelcoat”. The gelcoat, as generally known, is a hardenable resin that becomes the visible surface of the finished product.

Zone 1 includes a spray robot (illustrated schematically at 32A) which sprays toward the central exhaust plenum 28. Zone 3 provides for a relatively light barrier coat spray operation in combination with mold manipulation to provide for effective gravity-assisted spraying operations. Zone 3 also provide a concentrated spray in which the mold 24 or portions thereof are sprayed with a first layer of resin/catalyst/chopped fiberglass mixture referred herein as “chop” by a spray robot 32B. Zone 5 is a spray Zone in which the mold 24 is sprayed with a second layer of the resin/catalyst/chopped fiberglass mixture referred herein as “one chop” by a spray robot 32C. Zone 7 is a final spray Zone in which the mold 24 is sprayed with a foam support matrix and a cover coat by a spray robot 32D.

It should be understood that although a single robot is described in each of Zones 1, 3, 5 and 7, multiple robots will benefit from the present invention. It should further be understood that although robots are preferred for Zones 1, 3, 5 and 7, operators in proper protective equipment may additionally or alternatively be located in the spray Zones. In addition, the consolidation of spray operations minimizes the requirement for more highly skilled labor to the spray Zones or the required number of robots.

Zones 2, 4, 6, 8, 9, and 10 are mold operations which require minimal or low-concentration spraying and relatively uncomplicated manual tasks. It should be understood that the molds may transit the circuit 22, inside and outside booth 26, at a relatively slow pace such that time is provided to perform various operations. Alternatively, or in addition, the molds may increment at a relatively quick pace then stop such that time is provided to perform various operations. Various transit methods will benefit from the present invention.

Zone 9 is where a completed part is removed or “pulled” from the mold 22, i.e., demolded. Zones 9-10 are where the bare mold is wiped down and cleaned after demolding. It should be understood that these operations may be performed by robots and/or human workers. Moreover, these Zones may incorporate both automated and human performed operations.

Zone 10 provides for continued wiping of the mold prior to Zone 1. Zones 10 may also include a staging area for molds 24 such that damaged molds or the like maybe changed out with other molds without delaying operation of the system 20.

Zones 2, 4, 6 and 8 are primarily queues in which the previous spray operations are cured. The system 20 footprint is further reduced, as the curing Zones 2, 4, 6, and 8 are peripherally located about the central spray booth 26.

Referring also to FIG. 2, the molds 24 preferably stop for 3 minutes in each spray Zone 1, 3, 5 and 7. All the molds will therefore increment along the circuit 22 every three minutes. The time required for cure after each spray operation therefore provides the length of the cure rooms and thus the length of each leg 22a, 22b, 22c, and 22d. For example only, the spray operation of Zone 3 requires only six minute of cure time prior to the next operation while the spray operation of Zone 5 requires twenty-four minute of cure time prior to the next operation. Zone 6 extends radially away from booth 26 approximately four times the distance of Zone 4. That is, Zone 4 includes two stops (6 minutes total) while Zone 6 includes 8 stops (24 minutes total). It should be understood that should other spray times are require, the system 20 will be accordingly proportioned.

The foregoing description is exemplary rather than defined by the limitations within.

Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method of molding an article comprising the steps of:
(1) defining a closed circuit which passes through a central booth a plurality of times;
(2) transiting a plurality of open molds about the closed circuit; and
(3) performing a predetermined series of operations on each of the plurality of molds, at least two of said plurality of operations comprising an applying operation performed within the central booth.

2. A method as recited in claim 1, further comprising the step of:
transiting the plurality of open molds toward the central booth;
transiting the plurality of open molds through the central booth; and
transiting the plurality of open molds away from the central booth.

3. A method as recited in claim 1, wherein said step (2) further comprises the step of:
transiting the plurality of open molds about a cross-shaped closed circuit.

4. A method as recited in claim 1, further comprising the steps of:
transiting a first mold from a first curing operation toward the central booth;
transiting the first mold through the central booth;
performing a first applying operation to the first mold within the central booth; and
transiting the first mold away from the central booth.

5. A method as recited in claim 4, wherein said transiting away step comprises:
transiting the first mold through a second curing operation.

6. A method as recited in claim 1, further comprising the steps of:
exhausting the airflow from each of the applying operation though a common exhaust plenum.

7. A method as recited in claim 6, further comprising the steps of locating each of the applying operations around the common exhaust plenum.

8. A method as recited in claim 1, wherein the applying operation comprises an environmentally controlled applying operation.

9. A method as recited in claim 1, wherein the applying operation comprises a spraying step.

10. A method as recited in claim 1, further comprising the step of:
transiting the plurality of open molds toward the central booth for a first predetermined length;
transiting the plurality of open molds through the central booth; and
transiting the plurality of open molds away from the central booth for a second predetermined length.

11. A method as recited in claim 10, wherein the first and second predetermined length relates to a cure time for a previously performed applying operation.

12. A method of molding an article comprising the steps of:
(1) defining a closed circuit which passes through a central booth a plurality of times;
(2) transiting a plurality of open molds toward the central booth over a first predetermined distance;
(3) transiting the plurality of open molds through the central booth;
(4) performing a first applying operation within the central booth;
(5) transiting the plurality of open molds away from the central booth over a second predetermined distance;
(6) transiting a plurality of open molds toward the central booth over the second predetermined distance;
(7) transiting the plurality of open molds through the central booth;
(8) performing a second applying operation within the central booth; and
(9) transiting the plurality of open molds away from the central booth over a third predetermined distance.

13. A method as recited in claim 12, wherein said step (2) and said step (6) comprise:
transiting the plurality of open molds through a respective curing operation.

14. A method as recited in claim 12, wherein said step (5) and said step (9) comprise:
transiting the plurality of open molds through a respective curing operation.

15. A method as recited in claim 12, wherein the applying operation of said step (4) and said step (8) respectively comprise a spraying step.

16. A method as recited in claim 12, wherein said step (4) and said step (8) comprise:
performing an environmentally controlled applying operation.

17. A mold manufacturing system comprising:
a central booth;
a closed circuit passing though said central booth a plurality of times;
a plurality of open molds that transit along said closed circuit; and
a plurality of Zones located along said closed circuit, each of said Zones performing an operation to each of said plurality of open molds, one of said plurality of Zones comprising an applying operation performed within said central booth.

18. The mold manufacturing system as recited in claim 17, wherein said central booth contains a common exhaust plenum.

19. The mold manufacturing system as recited in claim 17, wherein said central booth comprises a plurality of booth areas about a common exhaust plenum.

20. The mold manufacturing system as recited in claim 19, further comprising a closable exit and entry for each of said plurality of booth areas.

21. The mold manufacturing system as recited in claim 17, wherein said closed circuit comprises a leg between each of said plurality of booth areas.

22. The mold manufacturing system as recited in claim 21, wherein each of said legs radially extend away from said central booth.

23. The mold manufacturing system as recited in claim 21, wherein one of said plurality of legs extend for a distance related to said applying operation.

24. The mold manufacturing system as recited in claim 17, wherein said closed circuit comprises a leg following said applying operation.

25. The mold manufacturing system as recited in claim 17, further comprising a curing queue along said leg.

26. The mold manufacturing system as recited in claim 25, wherein said leg extends for a distance related to said applying operation.

27. The mold manufacturing system as recited in claim 25, wherein said leg extends radially from said central booth.

28. The mold manufacturing system as recited in claim 17, wherein said closed circuit defines a plurality of legs such that said closed circuit comprises a cross shape.

29. A mold manufacturing system comprising:
a central booth having a first and a second booth area about a common exhaust plenum;
a closed circuit passing though said first and said second booth area;
a plurality of open molds that transit along said closed circuit; and
a plurality of Zones located along said closed circuit, each of said Zones performing an operation to each of said plurality of open molds, a first Zone of said plurality of Zones comprising a first applying operation performed within said first booth area and a second Zone of said plurality of Zones comprising a second applying operation performed within said first booth area.

30. The mold manufacturing system as recited in claim 29, wherein said closed circuit comprises a leg extending between an exit of said first booth area and an entry of said second booth area.

31. The mold manufacturing system as recited in claim 30, wherein said leg extends radially from said central booth.

32. The mold manufacturing system as recited in claim 29, wherein said leg extends for a distance related to said first applying operation.

33. The mold manufacturing system as recited in claim 32, further comprising a curing queue along said leg.

34. A method as recited in claim 29, wherein the first and second applying operation comprise an environmentally controlled applying operation.
